(19) United States
(12) Patent Application Publication
(10) Pub. No.: US 2021/0088725 A1
(43) Pub. Date: Mar. 25, 2021

(54) OPTICAL DEVICE PRODUCTION METHOD

(71) Applicant: SUMITOMO ELECTRIC INDUSTRIES, LTD., Osaka (JP)

(72) Inventor: Shigehiro NAGANO, Osaka-shi (JP)

(73) Assignee: SUMITOMO ELECTRIC INDUSTRIES, LTD., Osaka (JP)

(21) Appl. No.: 17/099,515

(22) Filed: Nov. 16, 2020

Related U.S. Application Data
(63) Continuation of application No. PCT/JP2019/022207, filed on Jun. 4, 2019.

(30) Foreign Application Priority Data
Jun. 12, 2018 (JP) 2018-111777

(51) Int. Cl. G02B 6/13; C03C 21/00

(52) U.S. Cl. CPC G02B 6/13; C03C 21/007

(57) ABSTRACT

A method for manufacturing an optical device includes a hydrogen-loading step, a laser irradiation step, and a light condensing point movement step. A continuous refractive index changed region is formed in a glass member by alternately repeating the laser irradiation step and the light condensing point movement step or performing the laser irradiation step and the light condensing point movement step in parallel. In the hydrogen-loading step, hydrogen is loaded into the glass member containing P₂O₅ as a main component. In the laser irradiation step, a femtosecond laser beam having a repetition frequency of 10 kHz or higher is condensed in the hydrogen-loaded glass member, and a light-induced change in refractive index is caused in the glass member. In the light condensing point movement step, a light condensing point position of the femtosecond laser beam is moved relative to the glass member.

The present disclosure relates to a method for manufacturing an optical device. This application is a continuation application of PCT/JP2019/022207 that is based upon and claims the benefit of priority from Japanese Patent Application No. 2018-111777, filed on Jun. 12, 2018; the entire contents of (or all of) which are incorporated herein by reference.

### TECHNICAL FIELD

### Background Art

In a technical field such as optical network communication, with the expansion of cloud services, the scale of data centers and the capacity of communication data are rapidly increasing. As an example, formation of an optical IC on the basis of silicon photonics and application of a multi-core optical fiber (hereinafter, referred to as “MCF”) as high-density optical wiring are under consideration, for example. Attention is being given to the MCF as the next generation large capacity optical fiber because the MCF can serve as a means of avoiding, by space division multiplexing, an allowable limit due to a fiber fuse caused by high-power light beam incident on an optical fiber. However, in order to adopt an optical component such as the MCF, a technique of connecting between adjacent MCFs or a technique of branch connection of each core of the MCF to a plurality of single-core fibers is essential. As components that enable connection between such optical components, a low-profile coupler, a grating coupler, and the like are available, for example. In particular, attention is being given to manufacture of a three-dimensional optical waveguide device that forms an optical waveguide in glass by laser drawing from the viewpoint of productivity and design flexibility.

For such a three-dimensional optical waveguide device based on laser drawing that has been announced so far, glass materials, dopant materials, amounts of dopants, and irradiation conditions of a femtosecond laser (800 nm) based on a titanium sapphire (Ti:S) laser are under study. For example, Patent Literature 1 discloses a method of spatially distributing a region where a change in refractive index is induced (refractive index modulated region) by irradiating glass containing a P₂O₅ component without containing a SiO₂ component with a femtosecond laser. In this method, an alkali metal oxide, an alkaline earth metal oxide, or the like is added to the glass, and thus, a melting point of the glass is lowered. As a result, it is easy to perform a molding process. In addition, chemical durability is enhanced by adding oxides of Group 14 except Si, Ti, and Zr to the glass. Furthermore, Patent Literature 1 discloses that B₂O₃, GeO₂, or the like which contributes to a high change in refractive index is added to the glass.

### CITATION LIST

### Patent Literature

Patent Literature 1: Japanese Unexamined Patent Publication No. 2010-70399

### Non Patent Literature

Non Patent Literature 1: Ishikawa Shinji, “Thermal Decay Analysis for Long-Period Optical Fiber Grating Written by UV-induced index change”, IEICE technical report, 11, 1999, pp. 19-24
Non Patent Literature 2: D. L. Williams, et al., “ENHANCED UV PHOTOSENSITIVITY IN BORON CODOPED GERMANOSILICATE FIBERS”, ELECTRONICS LETTERS, 7th January, 1993, Vol. 29, No. 1, pp. 45-47
Non Patent Literature 3: B. I. Greene, et al., Photoselective Reaction of H₂ with Germanosilicate Glass”, LEOS '94 (1994), Vol. 2, PD-1.2, pp. 125-126
Non Patent Literature 4: Masakiyo Tonoike, “The result of the finished national project on “High-efficiency Processing Technology for 3-D Optical Devices in Glass””, NEW GLASS Vol. 26, No. 3, 2011, pp.

33-44
Non Patent Literature 5: Junji Nishii, et al., “Ultraviolet-radiation-induced chemical reactions through one- and two-photon absorption process in GeO₂—SiO₂ glasses”, OPTICS LETTERS, Vol. 20, No. 10, May 15, 1995, pp. 1184-1186

### SUMMARY OF INVENTION

A method for manufacturing an optical device according to the present disclosure includes a hydrogen-loading step, a laser irradiation step, and a light condensing point movement step. A continuous refractive index changed region is formed in a glass member by alternately repeating the laser irradiation step and the light condensing point movement step or performing the laser irradiation step and the light condensing point movement step in parallel. In the hydrogen-loading step, hydrogen is loaded into the glass member containing P₂O₅ as a main component. In the laser irradiation step, a femtosecond laser beam having a repetition frequency of 10 kHz or higher is condensed in the hydrogen-loaded glass member, and a light-induced change in refractive index is caused in the glass member. In the light condensing point movement step, a light condensing point position of the femtosecond laser beam is moved relative to the glass member.

### BRIEF DESCRIPTION OF DRAWINGS

FIG. 1 is a flowchart for describing a method for manufacturing an optical device according to an embodiment of the present disclosure.

FIG. 2 is a diagram showing a structure of a manufacturing apparatus that executes the method for manufacturing an optical device according to the present disclosure.

FIG. 3 is a graph showing a measurement result of a change in transmittance relative to a wavelength of an incident light beam for each of different materials (P₂O₅, GeO₂, and B₂O₃) primarily forming a glass member.

### DESCRIPTION OF EMBODIMENTS

### Problem to be Solved by Present Disclosure

As a result of studying a conventional method for manufacturing an optical waveguide device, the inventors have found the following problems. That is, in the method disclosed in Patent Literature 1, in the refractive index modulated region formed by irradiation with the femtosecond laser, the structure is unstable, and the change in the refractive index with time is large. Further, since a difference in the refractive index between an irradiation region and a non-irradiation region of the femtosecond laser is small, light confinement is weak, and as a result, it is difficult to reduce a device size.

The present disclosure has been made in order to solve the above problems, and an object of the present disclosure is to provide a method for manufacturing an optical device for increasing a difference in refractive index between an irradiation region and a non-irradiation region of a femtosecond laser by forming a stable high refractive index region in glass.

### Effects of Present Disclosure

According to the present disclosure, it is possible to provide a method for manufacturing an optical device for increasing a difference in refractive index between an irradiation region and a non-irradiation region of a femtosecond laser by forming a stable high refractive index region in glass.

### Description of Embodiment of Present Disclosure

Details of an embodiment of the present disclosure will be individually listed and described. A method for manufacturing an optical device according to the embodiment includes a hydrogen-loading step, a laser irradiation step, and a light condensing point movement step. A continuous refractive index changed region is formed in a glass member by alternately repeating the laser irradiation step and the light condensing point movement step or performing the laser irradiation step and the light condensing point movement step in parallel. In the hydrogen-loading step, hydrogen is loaded into the glass member containing P₂O₅ as a main component. In the laser irradiation step, a femtosecond laser beam having a repetition frequency of 10 kHz or higher is condensed in the hydrogen-loaded glass member, and a light-induced change in refractive index is caused in the glass member. In the light condensing point movement step, a light condensing point position of the femtosecond laser beam is moved relative to the glass member.

Note that the “light-induced change in refractive index” means herein a change in refractive index in glass induced by irradiation of light such as laser beam. Further, the “change in refractive index” is defined by a maximum difference in refractive index Δn in the light irradiation region where a change in refractive index has been produced, with reference to a refractive index of a region other than the light irradiation region. The change in refractive index Δn in the glass induced by irradiation of light is a combination of a change in refractive index Δnp (hereinafter, referred to as “pressure-derived change in refractive index”) caused by pressure (compressive stress and/or tensile stress) remaining in the glass and a change in refractive index Δnd (hereinafter, referred to as “structure-derived change in refractive index”) caused by a bonding defect of a dopant material occurring in the glass or composition fluctuation in the glass.

The pressure-derived change in refractive index Δnp is produced by, for example, laser irradiation causing an increase in density of a specific region in the glass as described in Non Patent Literature 4 (about 0.015). Further, the structure-derived change in refractive index

And is produced by, for example, a refractive index increasing mechanism used in manufacture of fiber gratings and the like as described in Non Patent Literature 2, Non Patent Literature 3, and Non Patent Literature 5.

In Patent Literature 1, a quartz glass doped with a photosensitive material Ge is irradiated with a femtosecond laser to produce a large change in refractive index Δn (=Δnp+Δnd), but the change in refractive index is about 2% that is not enough. In order to further increase the change in refractive index Δn, H₂ needs to be loaded before irradiation.

In an aspect of the present embodiment, a glass member into which H₂ is loaded and which contains P₂O₅ as a main component is irradiated with a femtosecond laser beam, and a change in refractive index Δn of a laser beam irradiation region (light-induced region) is increased. Thus, the formation of the change in refractive index Δn is accelerated. Both the pressure-derived change in refractive index Δnp and the structure-derived change in refractive index Δnd are caused in the laser beam irradiation region. Since the glass member contains P₂O₅ as the main component, it is possible to increase the pressure-derived change in refractive index Δnp. Further, it is possible to further increase the structure-derived change in refractive index Δnd by the loading of H₂, and a larger change in refractive index Δn is formed (light confinement efficiency is improved). As a result, the radius of curvature in the refractive index changed region (optical waveguide region) formed in the glass member can be designed to be smaller, so that an optical device obtained can be reduced in size. Further, when the structure-derived change in refractive index occurs, stability of a refractive index changed region is improved by an effect of H₂ loaded into the glass. That is, a stable high refractive index region can be formed in the glass. Further, it is possible to reduce a manufacturing time by selecting an appropriate dopant material.

As an aspect of the present embodiment, the glass member may include at least one of an element Ge and an element B. In this case, the element contributes not only to the improvement of the refractive index in the refractive index changed region but also to the lowering of a melting temperature of the glass member.

As an aspect of the present embodiment, the glass member may contain one or more of an alkali metal and an alkaline earth metal. In this case, the alkali metal and the alkaline earth metal contribute to lowering the melting temperature of the glass member.

As an aspect of the present embodiment, the glass member may contain both Ge and B, and the femtosecond laser beam may have a wavelength in the range from 420 nm to 530 nm. In this case, both the pressure-derived change in refractive index Δnp and the structure-derived change in refractive index Δnd can be produced at the same position inside the glass member irradiated with the femtosecond laser beam.

As an aspect of the present embodiment, the hydrogen-loading step may include a step of holding the glass member in a hydrogen atmosphere of 10⁶ Pa or more.

### Details of Embodiment of Present Disclosure

A description will be given below of details of specific examples of the method for manufacturing the optical device according to the present disclosure with reference to the accompanying drawings. It should be noted that the present invention is not limited to these examples, and is intended to be defined by the claims and to include all modifications within the scope of the claims and their equivalents. Further, in a description of the drawings, the same components are denoted by the same reference numerals, and a redundant description will be omitted.

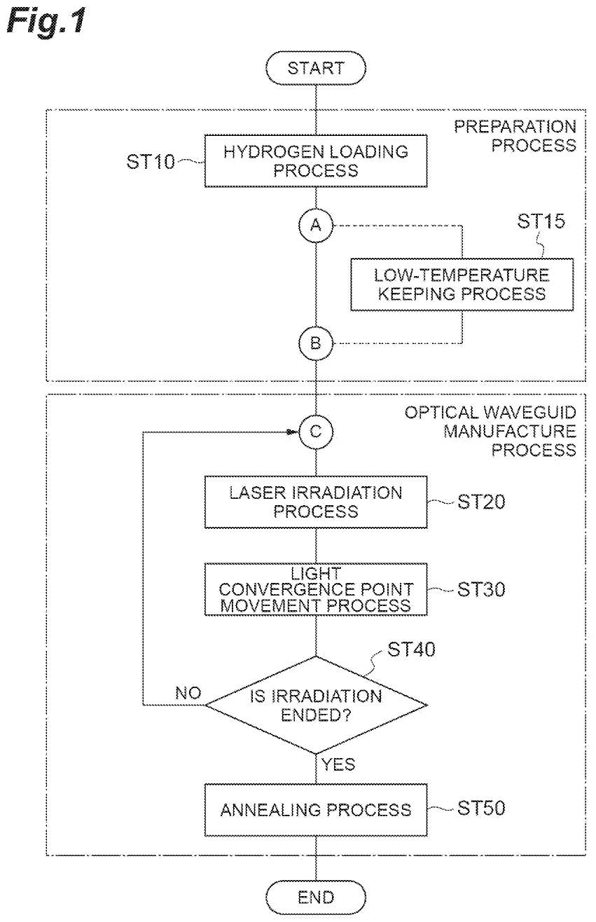

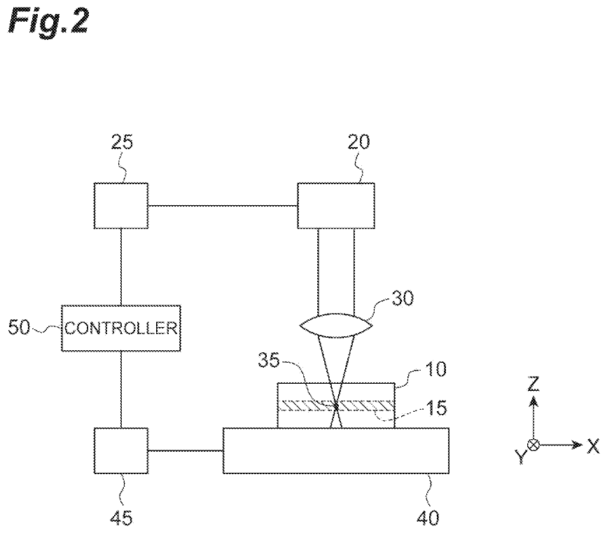

FIG. 1 is a flowchart for describing a method for manufacturing an optical device according to the present disclosure. Further, FIG. 2 is a diagram showing a structure of a manufacturing apparatus that executes the method for manufacturing an optical device according to the present disclosure.

The manufacturing apparatus shown in FIG. 2 includes a femtosecond laser 20, a laser driver 25 that drives the femtosecond laser 20, a light condensing optical system (condenser) 30, an X-Y-Z stage 40, a stage driver 45 that drives the X-Y-Z stage 40, and a controller 50 that controls action of each of the components.

The laser driver 25 controls power and repetition frequency of a pulsed laser beam (hereinafter, referred to as a “femtosecond laser beam”) output from the femtosecond laser 20 in accordance with an instruction from the controller 50. This allows the femtosecond laser 20 to output the femtosecond laser beam having a pulse width of several hundred femtoseconds or less. In particular, the femtosecond laser beam whose pulse width is set to several hundred femtoseconds or less is effective because its peak power can be made to 10⁵ W/cm² or higher. Further, the repetition frequency of the femtosecond laser beam output is preferably equal to or higher than 10 kHz, so as to smooth a refractive index and structure of an optical waveguide formed in a glass material. On a device placing surface of the X-Y-Z stage 40, a glass member 10 to be an optical device is placed.

A substrate material forming the glass member 10 does not contain a SiO₂ component and contains P₂O₅ having a low melting temperature as a main component. The “having P₂O₅ as a main component” means that P₂O₅ is contained with an amount of 51% or more of the whole by a mass fraction based on an oxide (that is, a ratio of a mass of P₂O₅ to a mass of the substrate material on the assumption that phosphorus is contained in the form of P₂O₅). With P₂O₅ as a substrate material, it is easy to vitrify the substrate material when P₂O₅ is 60% or less by mass fraction based on an oxide. Thus, a content range of P₂O₅ may be about 51% to 95% by mass fraction based on an oxide, and more preferably 51% to 60%.

A low melting temperature of the material is useful in forming the glass. Thus, an alkali metal oxide, an alkaline earth metal oxide, and the like are effective as a dopant material for lowering the melting temperature. Examples of the alkali metal oxide include Li₂O, Na₂O, and K₂O. Examples of the alkaline earth metal oxide include MgO, CaO, SrO, and BaO. Moreover, ZnO is used as another effective dopant material. It is effective to add one or more of the alkali metal oxide, the alkaline earth metal oxide, and the like to P₂O₅. Li₂O, Na₂O, K₂O, or the like which are the alkali metal oxide does not show a decrease in chemical durability when the addition amount (mass fraction based on an oxide, and the same applies below) is 30% or less. Thus, the addition amount range of the alkali metal oxide may be 0% to 30%, and more preferably 0% to 20%. Since MgO, CaO, SrO, or BaO which is the alkaline earth metal oxide do not deteriorate the stability of the glass when the addition amount is 30% or less, the addition amount range of the alkaline earth metal oxide may be 0% to 30%, and more preferably 0% to 20%.

Examples of the dopant material that improves the chemical durability of the glass member include SnO₂, TiO₂, and ZrO₂. When the addition amount of SnO₂, TiO₂, ZrO₂, or the like is 40% or less, it is difficult to devitrify the glass member, and it is difficult to raise the melting temperature. Thus, the addition amount range of SnO₂, TiO₂, ZrO₂, or the like may be 0% to 40%, and more preferably 0% to 30%.

Examples of such a dopant material contributing to an increase in refractive index when the femtosecond laser is emitted include B₂O₃, GeO₂, Al₂O₃, Ga₂O₃, In₂O₃, Bi₂O₃, and rare-earth oxides. In particular, the addition of at least one or more of B₂O₃ and GeO₂ is effective for increasing the high refractive index. When the addition amount of

B₂O₃, GeO₂, Al₂O₃, Ga₂O₃, In₂O₃, Bi₂O₃, the rare-earth oxide, or the like is 40% or less, it is difficult to devitrify the glass member, and it is difficult to raise the melting temperature. Thus, the addition amount range of B₂O₃, GeO₂, Al₂O₃, Ga₂O₃, In₂O₃, Bi₂O₃, the rare-earth oxide, or the like may be 0% to 40%, and more preferably 0% to 30%. Although it is considered that the addition amount of B₂O₃ and GeO₂ that greatly contribute to the high refractive index is increased, when it is considered that the devitrification and chemical durability of the glass, an appropriate addition amount of B₂O₃ and GeO₂ is 0% to 20%. When B₂O₃ is added, there is an effect of lowering the melting temperature of the glass member.

Examples of the dopant material used for a clarifying agent include Sb₂O₃. The addition amount of Sb₂O₃ may be 40% or less.

H₂ is pre-loaded into the glass member. Since the loading of the hydrogen into the glass member contributes to the stability after a change in refractive index and increase of refractive index, the hydrogen is a very important factor. The femto second laser beam output from the femtosecond laser 20 condenses, by the light condensing optical system 30, into the glass member 10 (light condensing point position 35) placed on the X-Y-Z stage 40. This causes a refractive index changed region 15 (optical waveguide) is formed in the glass member 10.

The stage driver 45 drives the X-Y-Z stage 40 in accordance with an instruction from the controller 50 to move the device placing surface of the X-Y-Z stage 40 along an X axis, a Y axis, or a Z axis. Such a structure causes the light condensing point position 35 of the femtosecond laser beam to move relative to the glass member 10. The controller 50 controls action of each of the laser driver 25 and the stage driver 45 as described above, so that the refractive index changed region 15 having a desired pattern (corresponding to a shape of the optical waveguide projected onto an X-Y plane containing information on a depth direction along the Z axis) is formed in the glass member 10 (manufacture of an optical waveguide device serving as the optical device).

Next, a description will be given, with reference to the flowchart of FIG. 1, of the method for manufacturing an optical device according to the present embodiment, in which the manufacturing apparatus configured as described above is used to manufacture an optical device (the optical device according to the present embodiment). Note that, in the following description, a case of manufacturing a three-dimensional optical waveguide device (optical device) in which the optical waveguide (refractive index changed region) having a desired pattern is formed will be described as an example.

The method for manufacturing an optical device according to the present embodiment includes a preparation process and an optical waveguide manufacture process. First, in the preparation process, the glass member 10 (for example, a parallel flat plate glass) to be the three-dimensional optical waveguide device is prepared and temporarily placed in a chamber. With the glass member 10 placed, 99.9% hydrogen gas is introduced into the chamber, and pressure in the chamber is maintained at 10 atm (approximately 10⁶ Pa) or higher. A hydrogen-loading period is in a range of from one day to four weeks. When a thickness of the glass material is, for example, 0.5 mm or more, the hydrogen-loading period may be set to 4 weeks or more depending on the balance of a diffusion rate of H₂, as needed. This causes hydrogen to be loaded into the glass member 10 (step ST10). Note that when the optical waveguide manufacture process is not performed immediately after a hydrogen-loading step in step ST10, the glass member 10 having the hydrogen loaded therein is kept at a low temperature of −10° C. or lower to suppress an escape of the hydrogen from the glass member 10 (step ST15). Note that step ST15 (low-temperature keeping process) is performed during a period indicated by points A and B in FIG. 1.

In the optical waveguide manufacture process, the optical waveguide (refractive index changed region 15) having a desired pattern is formed in the glass member 10 having the hydrogen loaded therein. Specifically, the glass member 10 having the hydrogen loaded therein is placed on the device placing surface of the X-Y-Z stage 40 immediately after step ST10, and irradiated with the femtosecond laser beam (step ST20). The controller 50 controls the laser driver 25 to cause the femtosecond laser 20 to output the femtosecond laser beam having an amount of energy causing a light-induced change in refractive index in the glass member 10 and having a repetition frequency of 10 kHz or higher. The femtosecond laser beam output from the femtosecond laser 20 condenses into the glass member 10 by the light condensing optical system 30 to cause the light-induced change in refractive index in the vicinity of the light condensing point position 35 of this femtosecond laser beam (condensing region). When a predetermined portion of the glass member 10 has been irradiated with the laser, the controller 50 controls the stage driver 45 to shift the position of the glass member 10 placed on the device placing surface of the X-Y-Z stage 40 (step ST30). As described above, in the light condensing point movement step (step ST30), the position where the glass member 10 is placed and/or the light condensing point position 35 of the femtosecond laser beam is continuously or intermittently changed, causing the light condensing point position 35 of the femtosecond laser beam to move within the glass member 10. Note that when the position where the glass member 10 is placed and/or the light condensing point position 35 of the femtosecond laser beam is continuously changed, the laser irradiation step (ST20) and the light condensing point movement step (ST30) may be performed in parallel.

Note that the laser irradiation step in step ST20 and the light condensing point movement step in step ST30, that is, the action control of the laser driver 25 and the action control of the stage driver 45 performed by the controller 50 are repeated until a pre-designed optical waveguide pattern is formed in the glass member 10 under fixed irradiation conditions or irradiation conditions changed when returning to point C in FIG. 1 (step ST40). When the optical waveguide (refractive index changed region 15) has been formed in the glass member 10 (step ST40), the glass member 10 is subjected to an aging treatment to keep Δn unchanged for a long time and is annealed to remove residual hydrogen (step ST50). Through the above processes (steps ST10 to ST50 or steps ST10 to ST50 including step ST15), the three-dimensional optical waveguide device is obtained.

Next, a description will be given of details of the laser irradiation step (step ST20) for manufacturing the three-dimensional optical waveguide device.

First, for the three-dimensional optical waveguide device to be manufactured, it is required that the laser beam is condensed in the glass member serving as a base material. That is, moving the condensing region of the laser beam (including the light condensing point position 35) relative to the glass member while increasing the refractive index in the condensing region (scanning a laser condensing region) forms the refractive index changed region having a desired pattern in the glass member. In order to form such the refractive index changed region having a desired pattern, a laser beam source and a light condensing optical system are required as an irradiation system, and an operation stage that operates in conjunction with the light condensing optical system is required. In the example shown in FIG. 2, the femtosecond laser 20 serving as the laser beam source and the laser driver 25, the condenser serving as the light condensing optical system 30, and the X-Y-Z stage 40 and the stage driver 45 serving as the operation stage are provided. The controller 50 controls the action of each of the components.

Mechanisms for increasing the refractive index in the glass member by causing the laser beam to condense in the glass member are classified into the following two mechanisms.

A first mechanism is a refractive index increasing mechanism using a Ti:S laser (a femtosecond laser having a wavelength of 800 nm or lower). In the refractive index increasing mechanism using the Ti:S laser, high-pressure plasma is generated in a region in the glass member to which the laser condenses. In the laser condensing region of the glass member, dynamic compression caused by an impact of the high-pressure plasma generates and propagates pressure waves outward, so that glass in the laser condensing region is made coarse. Further, after the laser irradiation, an elastic constraint applies a compressive stress to a center of the laser condensing region, so that a high-density glass region is formed in the glass member. At this time, the change in refractive index Δn in the high-density glass region becomes about 1.5% in percentage. The change in refractive index caused by the first mechanism corresponds to the pressure-derived change in refractive index Δnp.

Note that the laser wavelength used may be about 800 nm as described above, or may be in a range of from 420 nm to 530 nm. In the wavelength range of 800 nm or lower, a laser (for example, a Ti:S laser) that outputs a stable femtosecond laser beam is available.

The second mechanism is a mechanism causing a bonding defect by cutting the atomic bonding of dopant materials such as GeO₂ and B₂O₃ contained in the glass member by the femtosecond laser beam and changing the refractive index by the bonding defect. The bonding defect is caused, and thus, a change in high density of the glass due to the composition fluctuation. Accordingly, only the refractive index of the laser irradiation region is higher than that of the surrounding region. That is, the change in refractive index caused by the second mechanism is the structure-derived change in refractive index. Note that this second mechanism (structure-derived change in refractive index) is also used when forming a grating structure in a core of an optical fiber, for example.

In the second mechanism, a laser beam having a wavelength shorter than an absorption edge wavelength of the dopant material may be used in order to cut the atomic bonding of the dopant material. However, in this case, even in the region of the glass material present between a light incident surface of the glass member and a condensing region, the dopant material absorbs the laser beam toward the light condensing region (before light condensing), and the atomic bonding of the dopant material is cut. Accordingly, it is difficult to cause the change in refractive index only in the condensing region. Thus, in the present embodiment, the change in refractive index is caused by cutting the atomic bonding of the dopant material only in the condensing region by multiphoton absorption (mainly two-photon absorption). For example, in the case of the two-photon absorption, energy corresponding to half the wavelength of the laser beam is given to the glass material in the region where the two-photon absorption occurs. Accordingly, when half the wavelength of the laser beam is shorter than the absorption edge wavelength of the dopant material and the wavelength of the laser beam is longer than the absorption edge wavelength of the dopant material, it is possible to cut the atomic bonding of the dopant material in the region where the two-photon absorption occurs. Note that it is extremely easy to adjust the irradiation condition of the laser beam in which the two-photon absorption is caused only in the condensing region where light intensity becomes high and the two-photon absorption is not caused in the region of the glass material present between the light incident surface of the glass member and the condensing region.

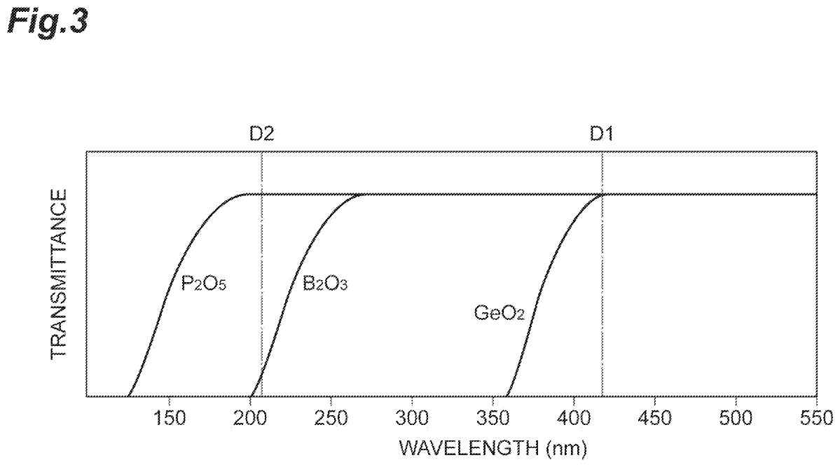

FIG. 3 is a graph showing a measurement result of a change in transmittance relative to a wavelength of an incident light beam for each of materials (P₂O₅, GeO₂, and B₂O₃) forming the glass member. As shown in FIG. 3, the transmittance of P₂O₅ gradually increases from 125 nm to 200 nm, the transmittance of B₂O₃ gradually increases from 200 nm to 265 nm, and the transmittance of GeO₂ gradually increases from 350 nm to 420 nm. When the glass member 10 contains GeO₂, energy corresponding to a wavelength of 420 nm or less may be generated by the two-photon absorption in order to cut the atomic bonding of GeO₂. Thus, an upper limit of a center wavelength of the laser beam is 840 nm. Further, when the center wavelength of the laser beam is set to be greater than 420 nm, it is possible to suppress the change in refractive index in the region of the glass material present between a light incident surface of the glass member 10 and a condensing region. Thus, the center wavelength range of the laser beam is greater than 420 nm and 840 nm or less. Further, when the glass member 10 contains B₂O₃, energy corresponding to a wavelength of 265 nm or less may be generated by the two-photon absorption in order to cut the atomic bonding of B₂O₃. Accordingly, the upper limit of the center wavelength of the laser beam may be 530 nm. That is, when the glass member 10 contains both GeO₂ and B₂O₃, the center wavelength range of the laser beam is more than 420 nm and 530 nm or less. In this case, the range of the energy generated by the two-photon absorption corresponds to the wavelength range of more than 210 nm and 265 nm or less. In the present embodiment, as an example, energy corresponding to the wavelength of 210 nm indicated by D2 may be generated by the two-photon absorption by setting the center wavelength of the laser beam to approximately 420 nm as indicated by D1 in FIG. 3. When the glass member 10 does not contain GeO₂ and B₂O₃, the laser beam before the laser beam condenses is not absorbed by GeO₂ and B₂O₃. Thus, the atomic bonding of P₂O₅ can be cut by the two-photon absorption by controlling the center wavelength range of the femtosecond laser beam to be more than 200 nm and 400 nm or less.

In addition, the laser beam source is required to emit a pulsed laser beam that has a high peak power and has a pulse width narrower than 1 picosecond. A fundamental wave or a wavelength converted wave of a solid laser, a gas laser, a fiber laser, or the like satisfies such requirement. In particular, a pulse width equal to or narrower than several hundred femtoseconds is effective because the peak power can be made equal to or higher than 10⁵ W/cm². Further, the repetition frequency of the pulsed laser beam output from the laser beam source is desirably equal to or higher than 10 kHz, so as to reduce the manufacturing time.

In the method for manufacturing an optical device described above, the glass member into which H₂ is loaded and which contains P₂O₅ is irradiated with the laser beam from the femtosecond laser, and thus, the change in refractive index Δn of the laser beam irradiation region (light-induced region) is increased. Accordingly, the formation of the change in refractive index Δn is accelerated. Both the pressure-derived change in refractive index Δnp and the structure-derived change in refractive index Δnd are caused in the laser beam irradiation region. In the present embodiment, since the glass member contains P₂O₅ as the main component, it is possible to increase the pressure-derived change in refractive index Δnp. Further, it is possible to further increase the structure-derived change in refractive index Δnd by the loading of H₂, and a larger change in refractive index Δn is formed (light confinement efficiency is improved). As a result, the radius of curvature in the refractive index changed region (optical waveguide region) formed in the glass member can be designed to be smaller, so that an optical device obtained can be reduced in size. Further, it is possible to reduce a manufacturing time by selecting an appropriate dopant material.

When a (hydrogen-treated) sample into which H₂ is loaded and a (non-hydrogen treated) sample into which H₂ is not loaded are compared, a relaxation rate of the increase amount of refractive index increased by irradiation with the femtosecond laser beam in the sample into which H₂ is not loaded is faster. That is, since activation energy of the non-hydrogen treated sample is lower than that of the hydrogen treated sample, a refractive index increased region written in the non-hydrogen treated sample is considered to be unstable from the viewpoint of a reaction rate. In the present embodiment, it is considered that the atomic bonding cut by the irradiation of the femtosecond laser beam is terminated by the hydrogen. Accordingly, it is possible to stabilize the refractive index changed region formed in the glass material to which GeO₂, B₂O₃, or the like is added. As stated above, when the structure-derived change in refractive index is caused, the stability of the refractive index changed region is improved by the effect of H₂ loaded into the glass. That is, a stable high refractive index region can be formed in the glass.

Further, when the glass member contains at least one of an element Ge and an element B, this element contributes to the improvement of the refractive index in the refractive index changed region, and contribute to the lowering of the melting temperature of the glass member. The glass member can be easily processed by lowering the melting temperature of the glass member.

Further, when the glass member contains one or more of the alkali metal and the alkaline earth metal, the alkali metal and the alkaline earth metal contribute to the improvement of the refractive index in the refractive index changed region, and contribute to the lowering of the melting temperature of the glass member. The glass member can be easily processed by lowering the melting temperature of the glass member.

Further, the glass member may include both Ge and B, and the wavelength of the femtosecond laser beam may range from 420 nm to 530 nm. In this case, the pressure-derived change in refractive index Δnp and the structure-derived change in refractive index Δnd can be produced at the same position inside the glass member irradiated with the laser beam from the femtosecond laser.

Further, the hydrogen-loading step may include a step of holding the glass member in a hydrogen atmosphere of 10⁶ Pa or higher. In this case, the loading of the hydrogen into the glass member 10 can be preferably performed.

The method for manufacturing an optical device according to the present invention is not limited to the above-described embodiment, and various modifications can be made. For example, although it has been described that at least GeO₂ and B₂O₃ are added to the glass member, the dopant material to be added to the glass member may be another exemplified material. In this case, the center wavelength of the femtosecond laser beam may be set to a wavelength at which the atomic bonding of the dopant material can be cut by the two-photon absorption.

Further, although it has been described that the glass member does not contain SiO₂, the glass member may contain SiO₂ in a small amount of, for example, less than 40%.

### REFERENCE SIGNS LIST

10 Glass member
15 Refractive index changed region (optical waveguide)
20 Femtosecond laser
25 Laser driver
30 Light condensing optical system (condenser)
35 Light condensing point position
40 X-Y-Z stage
45 Stage driver
50 Controller

What is claimed is:

1. A method for manufacturing an optical device comprising:
a hydrogen-loading step of injecting hydrogen into a glass member containing P₂O₅ as a main component;
a laser irradiation step of condensing a femtosecond laser beam having a repetition frequency of 10 kHz or more in the hydrogen-loaded glass member to cause a light-induced change in refractive index in the glass member; and
a light condensing point movement step of moving a light condensing point position of the femtosecond laser beam relative to the glass member,
wherein the laser irradiation step and the light condensing point movement step are alternately repeated or are performed in parallel to form a continuous refractive index changed region in the glass member.

2. The method for manufacturing an optical device according to claim 1,
wherein the glass member contains at least one of Ge and B.

3. The method for manufacturing an optical device according to claim 1,
wherein the glass member contains one or more of an alkali metal and an alkaline earth metal.

4. The method for manufacturing an optical device according to claim 1,
wherein the glass member contains both Ge and B, and
the femtosecond laser has a wavelength in a range from 420 nm to 530 nm.

5. The method for manufacturing an optical device according to claim 1,
wherein the hydrogen-loading step includes a step of holding the glass member in a hydrogen atmosphere of 10⁶ Pa or more.
